(19) United States
(12) Patent Application Publication
(10) Pub. No.: US 2007/0052132 A1
(43) Pub. Date: Mar. 8, 2007

(54) Method and system for cleaning molded items

(76) Inventors: Roman C. Gutierrez, Arcadia, CA (US); Kumaraswamy Jayaraj, San Diego, CA (US); Robert J. Calvet, Pasadena, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/219,258

(22) Filed: Sep. 2, 2005

(51) Int. Cl. B29C 45/00; B29C 71/00; B08B 3/00; B29B 15/00; B29B 7/00

(52) U.S. Cl. 264/233; 264/328.18; 264/343; 134/34; 134/198

(57) ABSTRACT

A method for cleaning glass from a molded item includes applying hydrofluoric acid to the molded item. The molded item can be an injection molded item made from a glass filled polymer material. For example, hydrofluoric acid can be applied by immersion, spraying, exposure to vapors, or brushing. The molded item can be friction cleaned, e.g., scrubbed, and/or cleaned via oxygen plasma prior to the application of hydrofluoric acid.

### TECHNICAL FIELD

The present invention relates generally to injection molding. The present invention relates more particularly to a way to cleaning glass debris from injection molded items that have a glass filler.

### BACKGROUND

The use of fillers in the polymer material used in injection molding processes is well known. Fillers reduce the amount of polymer material required to manufacture an injection molded item. Fillers also modify the physical properties of the injection molded item.

For example, glass fiber fillers can be used to increase the strength of an injection molded item. By adding glass fibers to the polymer that is used in the injection molding process, the resulting molded item can have more tensile strength, for example, than a similar item that lacks the glass fiber filler.

However, although the use of such fillers has proven generally useful for its intended purposes, the use of fillers does possess inherent deficiencies which detract from the overall desirability thereof. For example, after the molding process superfluous fillers such as glass fibers can remain upon the surface, extend from beneath the surface to above the surface, and/or be just beneath the surface of a molded item. Such superfluous glass fibers or debris can interfere with the desired functioning of the molded item and/or interfere with the desired functioning of other items.

Glass fibers can undesirably interfere with the operation of mechanical systems. This is particularly true for very small, delicate mechanical systems such as MEMS devices. Glass fibers can jam small mechanisms. Glass fibers can increase the coefficient of friction between moving surfaces so as to inhibit their relative motion. Thus, glass fibers can reduce the efficiency of small mechanisms or prevent their operation altogether.

Glass fibers can also interfere with the proper operation of optics. When glass fibers find their way onto optical surfaces, they then obstruct the light path. Glass fibers can also introduce diffraction effects that undesirably limit the performance of optical systems.

Glass fibers can contaminate systems that are chemically sensitive. Glass fiber can find their way into reactants where they can adversely affect the outcome of a chemical reaction. Although the glass itself is typically not very reactive, the glass fibers can carry a variety of reactants along with them. For example, UV protectants, plasticizers, and pigments are typically added to the polymers used in the injection molding process. These substances tend to coat the surfaces of the fillers that are also added to the polymer. The substances can also be reactive and can thus undesirably interfere with chemical reactions, particularly those chemical reaction used in measurement and analysis

Therefore, it is desirable to provide a method and system for cleaning superfluous fillers from molded items so as to inhibit such debris from adversely affecting the function of the molded items, as well as other items.

### BRIEF SUMMARY

Systems and methods are disclosed herein to provide for the cleaning of superfluous filler from a molded item. According to one aspect, the present invention comprises applying a filler dissolving substance to the molded item.

More particularly, hydrofluoric acid can be applied to the molded item to dissolve glass filler therefrom. The molded item can comprise an injection molded item. For example, the molded item can comprise a glass fiber filled polymer. The glass fibers can generally have a width of between approximately 2 microns and approximately 10 microns, for example. Other widths are also possible.

Hydrofluoric acid can be applied to the molded item by such methods as immersing the molded item in hydrofluoric acid, spraying the molded item with hydrofluoric acid, exposing the molded item to hydrofluoric acid vapor, and brushing hydrofluoric acid onto the molded item. Other methods of applying the hydrofluoric acid to the molded item may similarly be used.

According to one aspect of the present invention, the hydrofluoric acid is applied sufficiently so as to dissolve glass fibers that extend from the surface to an interior of the molded item. In this manner, glass and other substances that are disposed beneath the surface of the molded item are removed.

The molded item can be prepared so as to enhance the effectiveness of glass removal with hydrofluoric acid. For example, the molded item can be scrubbed and/or subjected to plasma cleaning. Indeed, scrubbing can optionally be performed in a manner that exposes glass fibers that are either partially or entirely beneath the surface of the molded item. That is, a thin layer of polymer can be removed so as to expose glass fiber therebeneath. Thus, the subsequent application of hydrofluoric acid to the molded item removes the previously covered glass fiber.

One or more aspects of the present invention provide a method and system for cleaning superfluous fillers from molded items so as to inhibit such debris from adversely affecting the function of the molded items, as well as other items.

This invention will be more fully understood in conjunction with the following detailed description taken together with the following drawings.

### BRIEF DESCRIPTION OF THE DRAWINGS

FIG. 1 is a cross-sectional view of a representative molded item showing a glass fiber that is entirely upon a surface thereof, another glass fiber that is partially above the surface thereof and that is partially below the surface thereof, and a glass fiber that is entirely below (but close to) the surface thereof;

FIG. 2 is flow chart showing a method for removing glass fibers from a molded item, according to an exemplary embodiment of the present invention; and

FIG. 3 is a block diagram showing a system for removing glass fibers from a molded item, according to an exemplary embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION OF THE INVENTION

A method and system for removing debris, such as filler material, from a molded item are disclosed. For example, glass fiber filler on the surface of a molded item, partially on the surface and partially below the surface of the molded item, and/or entirely below the surface of the molded item can be removed. Removal of the debris mitigates the likelihood of the debris interfering with the function of the molded item and/or other items.

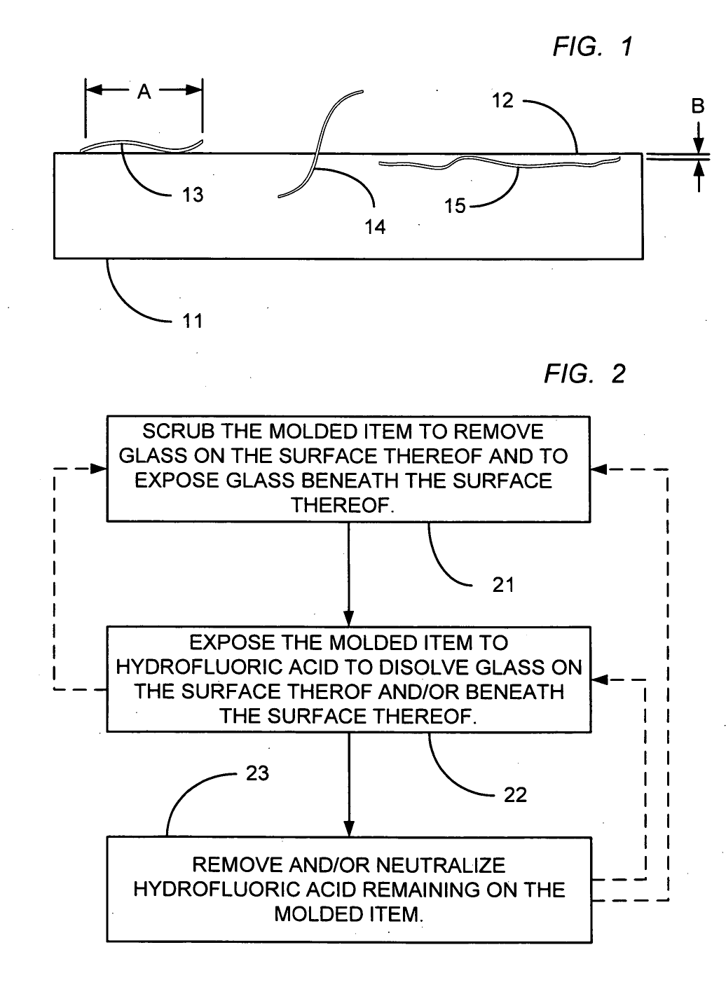

Referring now to FIG. 1, a molded item 11 has glass fibers upon or near a surface 12 thereof. The glass fibers can include glass fiber 13 that is entirely upon surface 12, glass fiber 14 that is partially above surface 12 and partially below surface 12, and glass fiber 15 that is beneath surface 12 (but that is typically close to surface 12).

It is sometimes desirable to remove those glass fibers 13 and 14 that are at least partially above surface 12. Thus, undesirable interference by glass fibers 13 and 14 (and by substances on glass fibers 13 and 14) with mechanical, optical, and chemical processes can be mitigated.

It can sometimes even be desirable to remove glass fiber 15 that is beneath surface 12, but which is close enough to surface 12 so as to be likely to undesirably interfere with mechanical, optical, or chemical process. Such fiber 15 can be released from molded item 11 as surface 12 wears. Such fiber 15 can also adversely affect the finish of surface 12, even if it is not released from molded item 11, such as by causing bumps or rough spots in surface 12.

Referring now to FIG. 2, according to one embodiment the method of the present invention comprises using friction to clean molded item 11. For example, the molded item can be scrubbed to remove glass fiber, 13 and 14, on the surface 12 or partially on the surface 12 of molded item 11, as indicated in block 21. Scrubbing or other frictional cleaning can also remove a thin layer of the polymer material so as to expose glass fiber 15 that is near surface 12, as further indicated in block 21. One exposed, scrubbing or other cleaning can remove glass fiber 15.

Molded item 11 is then exposed to hydrofluoric acid to dissolve glass fiber on surface 12 and/or beneath surface 12, as indicated in block 22. When at least a portion of a fiber is not covered by polymer such that the portion is exposed to hydrofluoric acid, then the hydrofluoric acid can continue to dissolve a further portion of the fiber that is disposed beneath the surface of molded item 11.

Any hydrofluoric acid remaining upon molded item 11 can subsequently be removed or neutralized, as indicated in block 23. Such cleaning and/or neutralization of the hydrofluoric acid is discussed in detail below.

Molded item 11 can be exposed to hydrofluoric acid by immersing it in hydrofluoric acid or a solution containing hydrofluoric acid. Molded item 11 can be exposed to hydrofluoric acid by exposing it to hydrofluoric acid vapor or to a vapor containing a solution containing hydrofluoric acid. Molded item 11 can be exposed to hydrofluoric acid by spraying it with hydrofluoric acid or a solution containing hydrofluoric acid. Molded item 11 can be exposed to hydrofluoric acid by brushing it with hydrofluoric acid or a solution containing hydrofluoric acid. Other methods for exposing molded item 11 to hydrofluoric acid can likewise be used.

As indicated by the exemplary dashed lines, the above described acts can be performed in a variety of different orders or combinations. That is, the order can be changed from that described above and/or the acts can be repeated, as desired.

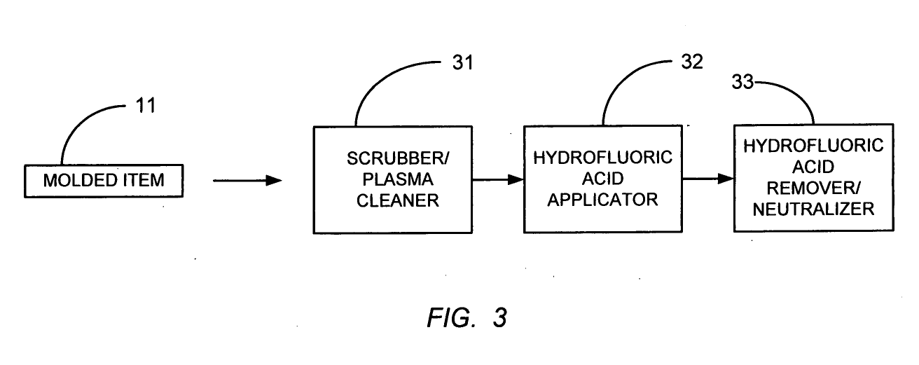

Referring now to FIG. 3, an exemplary system for cleaning glass fiber from molded item 11 is shown. Molded item 11 is scrubbed or cleaned in a scrubber and/or plasma cleaner 31. Scrubber and/or plasma cleaner 31 can comprise one or more brushes that are configured to brush glass fiber from molded item 11. The brushes can also be configured to remove a thin layer of polymer material from surface 12 of molded item 11, so as to expose glass fiber just beneath surface 12, as discussed above.

Scrubber and/or plasma cleaner 31 can comprise a plasma cleaner. The plasma cleaner can be an oxygen plasma cleaner. The plasma clean can use oxygen, hydrogen, argon, or another type of plasma to remove glass fiber from surface 12 of molded item 11.

Hydrofluoric acid applicator 32 applies hydrofluoric acid to molded item 11, such as via immersion, exposure to vapor, spraying, or brushing. Indeed, hydrofluoric acid applicator may apply hydrofluoric acid to molded item 11 by any desired combination of such methods. For example, combination of methods may be used to assure adequate application of the hydrofluoric acid.

Hydrofluoric acid remover/neutralizer can use any desired method or combination of methods to remove and/or neutralize any hydrofluoric acid remaining on molded item 11 after hydrofluoric acid has been applied thereto via hydrofluoric acid applicator 32. Various methods for mechanically removing hydrofluoric acid from molded item 11 can be used. For example, brushing, agitation, irrigation, and/or the application of ultrasonic energy can be used to remove or help remove hydrofluoric acid from molded item 11. Similarly, various chemical can be used to neutralize hydrofluoric acid on molded item 11. Various bases and/or buffering solutions may be used to neutralize or otherwise render safe the hydrofluoric acid and/or to provide a desire pH level.

According to one aspect of the present invention, the cleaning system can comprise any desired combination of scrubbers/plasma cleaners 31, hydrofluoric acid applicators 32, and/or hydrofluoric acid neutralizers 33. For example, the cleaning system can comprise a scrubber, a first hydrofluoric acid applicator, a hydrofluoric acid remover/neutralizer, a plasma cleaner, a second hydrofluoric acid applicator, and a second hydrofluoric acid remover/neutralizer, that are configured to be used in that order.

Hydrofluoric acid is used according to the above discussion because it etches or dissolves glass, but is relatively innocuous to the molded polymer material. Those skilled in the art will appreciate that other acids, solvents or chemicals may similarly be utilized. Generally, such substances can be chosen such that they selectively react with the filler material at a substantially faster rate than they react with the polymer material.

Although the removal of glass fiber is discussed herein, those skilled in the art will appreciate that other types of glass filler may similarly be removed from a surface of a molded item. For example, glass beads may similarly be removed from a surface of a molded item. Indeed, fillers formed of materials other than glass can similarly be removed from items other than molded items. Thus, discussion of glass fibers is by way of example only and not by way of limitation.

Thus, the present invention provides a method and system for cleaning superfluous fillers from molded items so as to inhibit such fillers from adversely affecting the function of the molded items, as well as other items.

Embodiments described above illustrate, but do not limit, the invention. It should also be understood that numerous modifications and variations are possible in accordance with the principles of the present invention. Accordingly, the scope of the invention is defined only by the following claims.

1. A method for cleaning filler from a molded item, the method comprising applying a filler dissolving substance to the molded item.

2. A method for cleaning glass from a molded item, the method comprising applying hydrofluoric acid to the molded item.

3. The method as recited in claim 2, wherein the molded item comprises an injection molded item.

4. The method as recited in claim 2, wherein the molded item comprises a glass filled polymer.

5. The method as recited in claim 2, wherein the molded item comprises a glass fiber filled polymer.

6. The method as recited in claim 2, wherein the molded item comprises a polymer that is filled with glass fibers that generally have a length of between approximately 2 microns and approximately 10 microns.

7. The method as recited in claim 2, wherein applying hydrofluoric acid to the molded item comprises immersing the molded item in hydrofluoric acid.

8. The method as recited in claim 2, wherein applying hydrofluoric acid comprises spraying the molded item with hydrofluoric acid.

9. The method as recited in claim 2, wherein applying hydrofluoric acid comprises exposing the molded item to hydrofluoric acid vapor.

10. The method as recited in claim 2, wherein applying hydrofluoric acid comprises brushing the molded item with hydrofluoric acid.

11. The method as recited in claim 2, wherein the hydrofluoric acid is applied sufficiently so as to dissolve glass fibers that extend from the surface to an interior of the molded item.

12. The method as recited in claim 2, further comprising scrubbing the molded item prior to applying hydrofluoric acid to the item.

13. The method as recited in claim 2, further comprising scrubbing the molded item sufficiently so as to expose glass that was previously not exposed, prior to applying hydrofluoric acid to the item.

14. The method as recited in claim 2, further comprising exposing the molded item to plasma prior to applying hydrofluoric acid to the item.

15. A method for producing an injection molded item, the method comprising:
injection molding the item using a glass filled polymer; and
cleaning the injection molded item with hydrofluoric acid.

16. A molded item formed by a method, the method comprising applying hydrofluoric acid to the molded item.

17. A system for cleaning glass debris from a molded item, the system comprising an applicator configured to apply hydrofluoric acid to molded items.

18. The system as recited in claim 17, wherein the applicator is configured to immerse the molded item in hydrofluoric acid.

19. The system as recited in claim 17, wherein the applicator is configured to spray the molded item with hydrofluoric acid.

20. The system as recited in claim 17, wherein the applicator is configured to expose the molded item to hydrofluoric acid vapors.

21. The system as recited in claim 17, wherein the applicator is configured to brush the molded item with hydrofluoric acid.

22. The system as recited in claim 17, further comprising a scrubber configured to scrub the molded item prior to having the applicator apply hydrofluoric acid thereto.

23. The system as recited in claim 17, further comprising a plasma cleaner configured to clean the molded item prior to having the applicator apply hydrofluoric acid thereto.

24. The system as recited in claim 17, further comprising an oxygen plasma cleaner configured to clean the molded item prior to having the applicator apply hydrofluoric acid thereto.

25. A system for cleaning glass debris from molded item, the system comprising:
means for scrubbing the molded item so as to remove glass from a surface thereof and so as to expose glass beneath the surface thereof; and
means for dissolving glass on the surface of the molded item and beneath the surface of the molded item.
